(19) United States
(12) Patent Application Publication
(10) Pub. No.: US 2023/0252373 A1
(43) Pub. Date: Aug. 10, 2023

(54) METHOD TO FORECAST HURRICANE-INDUCED POWER LOSS FROM SATELLITE NIGHTLIGHTS

(71) Applicants: Research Foundation of the City University of New York, New York, NY (US); New York University, New York, NY (US); Brookhaven Science Associates, LLC, Upton, NY (US)

(72) Inventors: Jorge E. González-Cruz, Northport, NY (US); Juan P. Montoya-Rincon, New York, NY (US); Shams Azad, New York, NY (US); Masoud Ghandehari, New York, NY (US); Michael P. Jensen, New York, NY (US)

(21) Appl. No.: 18/164,330

(22) Filed: Feb. 3, 2023

Related U.S. Application Data
(60) Provisional application No. 63/306,624, filed on Feb. 4, 2022.

(51) Int. Cl. G06Q 10/0631; G06Q 10/04; G06Q 50/06; G06N 20/00

(52) U.S. Cl. CPC G06Q 10/0631; G06N 20/00; G06Q 10/04; G06Q 50/06; G01W 1/00

(57) ABSTRACT

A predictive method that uses satellite-based nighttime light (NTL) observations as a proxy for power outage data that occurred during a hurricane. The NTL data is provided to a machine learning module along with exploratory variables. The module forecasts hurricane-induced power loss based on the NTL and exploratory variables. The method does not require any data from the utility, making it useful for isolated regions or regions with limited power outage records.

### CROSS-REFERENCE TO RELATED APPLICATIONS

This application claims priority to, and is a non-provisional of, U.S. Pat. Application Serial No. 63/306,624 (filed Feb. 4, 2022) the entirety of which is incorporated herein by reference.

### STATEMENT OF FEDERALLY SPONSORED RESEARCH OR DEVELOPMENT

This invention was made with Government support under grant number CBET-1832678 awarded by the National Science Foundation. The government has certain rights in the invention.

### BACKGROUND OF THE INVENTION

Hurricanes are a dominant disaster in many parts of the world, always causing serious power outages throughout the islands. Hurricane Maria was a prime example, causing unimaginable destruction of the power infrastructure of Puerto Rico. Consequently, one month after the hurricane landfall, approximately 80% of the population was still without power. After an event of such massive destruction, the electric power restoration process progresses very slowly. This timeline can be improved using power outage forecast models that help identify the vulnerable places before the hurricane landfall. Generally, these models are trained with historical power outage records, associated data on weather conditions, and additional information about the natural and built environments. One challenge that is often faced is the lack of availability of reported power outage records for the desired utility area. This data is often incomplete, difficult to acquire, proprietary, or may even be non-existent.

Developing new approaches that do not require actual power outage records is relevant to the current state of the field. Unfortunately, to date, no approach has been entirely satisfactory. An improved method is therefore desired.

The discussion above is merely provided for general background information and is not intended to be used as an aid in determining the scope of the claimed subject matter.

### SUMMARY

This disclosure provides a predictive method that uses satellite-based nighttime light (NTL) observations as a proxy for power outage data that occurred during a hurricane. The NTL data is provided to a machine learning module along with exploratory variables. The module forecasts hurricane-induced power loss based on the NTL and exploratory variables. The method does not require any data from the utility, making it useful for isolated regions or regions with limited power outage records. Some prior art reports have used post-hurricane satellite nightlight data to assess the damage and recovery after-the-fact but none have successfully used this publicly available data to make forecasts of future hurricane induced power loss. Previous efforts to forecast power infrastructure damage have relied entirely on power outage reports (provided by the utility) which are confidential and usually non existent for under developed regions.

In a first embodiment, a method of forecasting hurricane-induced power loss, without using power outages records is provided. The method comprising: aggregating explanatory variables selected from a group consisting of maximum wind speed, duration of wind speed greater than 20 mph, duration of wind speed greater than 30 mph, duration of wind speed greater than 40 mph, cumulative rainfall, human population, elevation, land cover, and combinations thereof, the aggregating occurring for at least one time period when hurricane-induced power loss occurred over a geographic area due to a hurricane; extracting radiance data from satellite nighttime light (NTL) data for the geographic area during the at least one time period when hurricane-induced power loss occurred, thereby creating extracted radiance data that includes pre-hurricane radiance data and post-hurricane radiance data; approximating a historical power loss by calculating a difference between the pre-hurricane radiance data and the post-hurricane radiance data; training at least one machine learning model to predict a future power loss by using the explanatory variables and the historical power loss; and forecasting hurricane-induced power loss using the at least one machine learning model, thereby producing a forecasted power loss.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a flow diagram depicting one method for forecasting hurricane-induced power loss, without using power outages records.

FIG. 2 is a box plot showing log-transformed pixel-level NTL radiance for the Island. Radiance distribution before H-Irma is demonstrated by 20 Aug - 24 Aug, (Pre-Irma) where 8 Sep - 11 Sep (Post-Irma) shows the radiance immediately after the landfall H-Irma. Between 17 and 19 Sep (Pre-Maria), the power was fully recovered from the loss caused by H-Irma. 25 Sep - 30 Sep (Post-Maria) shows the distribution after the landfall of H-Maria.

FIG. 3A and FIG. 3B are intensity maps showing power loss as a result of Hurricane Irma (FIG. 3A) and Hurricane Marie (FIG. 3B) at the towns and subdivisions spatial resolution.

FIG. 4A and FIG. 4B are bar graphs showing the frequency density of power loss in Hurricane Irma and Hurricane Maria respectively.

FIG. 5A, FIG. 5B and FIG. 5C are graphs of predicted values versus actual values (fitted) of different machine learning models including BART (FIG. 5A), RF (FIG. 5B) and XGBoost (FIG. 5C).

FIG. 6 is a graph depicting the relative importance of each of the exploratory variables in the RF machine learning model.

FIGS. 7A to 7F are partial dependence plots of select exploratory variables used in the RF machine learning model.

FIG. 8 is a quantile-quantile plot (QQ-plot) from the RF machine learning model.

### DETAILED DESCRIPTION OF THE INVENTION

This disclosure provides a predictive method that relies on satellite-based nighttime light (NTL) observations as a proxy for power outage data. The method does not require any data from the utility, making it useful for isolated regions or regions with limited power outage records. In one embodiment, the disclosed method utilizes a satellite-based Visible Infrared Imaging Radiometer Suite (VIIRS) night light data product as a surrogate for the power delivery to predict hurricane-induced power outages in areas having limited to nonexistent historical data records. The processed satellite data is then used along with geographic variables, and simulated weather data to formulate machine learning-based algorithms to predict power outages for future hurricane events.

To provide a proof of concept, the disclosed method is applied in the context of the Puerto Rico catastrophic storms, Hurricane Maria and Irma in August and September 2017.

The disclosed method differs from traditional power outage forecast models in numerous ways. For example, the disclosed method a) can be trained and deployed without requiring any data from the utility (i.e. power outages records); and b) is fully based on publicly available data, mainly satellite-based nighttime lights. The disclosed method provides a power outage forecast model that does not rely on power outage records provided by the utility

The disclosed method is particularly useful in areas where power outages records are not recorded or are incomplete and permits one to anticipate where major damage is going to happen after a hurricane event. This facilitates critical infrastructure management and also permits industry to be prepared for hurricane-induced blackouts. The power loss forecasting method has global implications as it can be implemented to any city or neighborhood around the world.

To provide an illustration of the disclosed method, two storms were considered for the development of the power outage prediction model: Hurricanes Irma and Maria. Hurricane Irma contacted Puerto Rico in August 2017. Hurricane Maria made landfall in Puerto Rico on Sep. 20, 2017. Almost all of the 2,400 miles of transmission lines, 30,000 miles of distribution lines, and 342 substations were damaged by the storm. The recovery process of the Puerto Rico power grid was slow due to its near-complete destruction. After one month, less than 20% of the total power capacity had been restored. The preparedness for such events can be improved by anticipating the likely location and timing of storm-induced damage to the power grid. Primarily, this increased preparedness will help utility companies and emergency managers to direct restoration plans, allowing for a more efficient repair and recovery process after the extreme weather event.

Multiple weather explanatory variables (Independent Variables) were used in the model to describe the destructive capabilities of a hurricane. Moreover, additional non-weather-related variables were also considered. These variables describe potential contributing risks, such as trees near the overhead lines, or provide information on the energy infrastructure.

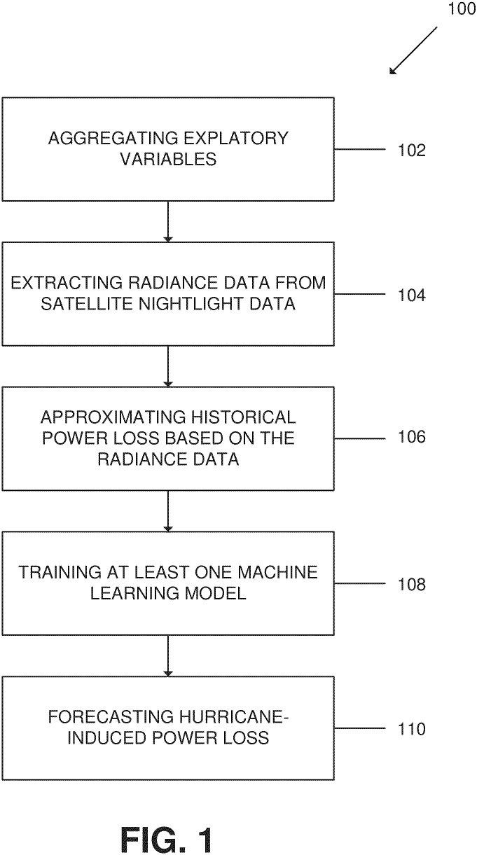

FIG. 1 depicts a method 100 for forecasting hurricane-induced power loss, without using power outages records. In step 102 of method 100, explanatory variables are selected for subsequent input into a machine learning module. A variety of explanatory variables are known to those skilled in the art and include, for example, maximum wind speed, duration of wind speed greater than 20 mph, duration of wind speed greater than 30 mph, duration of wind speed greater than 40 mph, cumulative rainfall, human population, elevation, land cover and combinations thereof. The aggregating occurs for at time period during which time hurricane-induced power loss occurred. In one embodiment, the explanatory variables consist solely of meteorological variables (e.g. wind speed parameters, cumulative rainfall), geographic variables (e.g. elevation, land cover such as tree density) and demographic variables (e.g. human population density) that are widely available from world-wide from weather forecasting databases. The explanatory variables omit power outage reports. Such explanatory variables are not dependent on power providers (electrical utility providers) which are often unreliable or unavailable in many parts of the world.

The disclosed example employed a single-layer urban canopy version of the Weather Research and Forecasting (WRF v 3.8.1) model which is a numerical weather prediction system developed by the National Center for Atmospheric Research (NCAR) to simulate the meteorological variables used in this example. For domain configuration, three two-way nested domains were employed. The Mesoamerican and Caribbean regions are covered under the parent domain at a spatial resolution of 25 km (144 points by 100 points). The Caribbean Sea, Dominican Republic, and the island of Puerto Rico are included in the second domain, which has a spatial resolution of 5 km (306 points by 191 points), while the entire island of Puerto Rico is included in the third domain, which has a spatial resolution of 1 km (336 points by 156 points). The center of the island contains the Cordillera Central mountain range with elevations as high as 1300 meters. For the 1 km domain, the cumulus parameterization was disabled because WRF can explicitly resolve convective processes at this resolution. The model had 50 vertical levels, 35 of which are below 2 km in height. Two simulations were conducted, from September 4^{th} to 9^{th}, and from September 19 to 22, 2017 that covered both Hurricane Irma and Hurricane Maria, respectively.

As part of this example, an ensemble of model simulations of Hurricane Maria was considered that included variation in the resolution of the boundary and initial conditions, the planetary boundary layer (PBL) schemes and the cumulus parameterizations. The explanatory variables output were used by the ensemble member that best reproduced the observed storm track. Hurricane Irma results were validated with ground station data from TJSJ (Luis Munoz Marin International Airport) and TJNR (Jose Aponte Hernandez Airport) airports.

For Hurricane Irma, data from September 6 and 7 was used, with a resolution of 1 km ×1 km. The simulation provided the wind in its U and V components. The maximum wind speed magnitude in each grid cell over time was determined. The center and northeast part of the island experienced the greatest maximum wind speeds during Hurricane Irma, where the highest power loss occurred. Furthermore, the cumulative precipitation for each event is calculated as the sum of the hourly precipitation at each location over the lifecycle of the storm. The highest rainfall totals for Hurricane Irma occurred in the same regions as the greatest maximum wind speeds.

For Hurricane Maria, a similar processing method was used to find the maximum value in each grid cell throughout the whole event. The wind speed in Hurricane Maria was significantly higher than Hurricane Irma, with speeds as high as 145 MPH (miles per hour). Furthermore, the duration of high winds in the service area was determined from the WRF simulated wind speed. Specifically, the duration of wind speed greater than 20, 30, and 40 MPH, resulting in a total of four wind-related variables in the training dataset. For Hurricane Maria, model outputs from September 20 and September 21 were used. The greatest precipitation in Hurricane Maria was located around the center of the island, with a maximum value of 25 inches.

In additional to the weather data, land surface elevation, population, and land cover were added as static geographic variables in the model. The land surface elevation was obtained from the United States Geological Survey. The dataset has a horizontal resolution of 100 m × 100 m. The population data was obtained from the United States Census, providing an estimation of the population by town. The land cover dataset was downloaded from the National Land Cover database, with a resolution of 30 m × 30 m, including twelve different land classes. Most of the island is covered by evergreen forest, which presents a significant risk to the overhead transmission and distribution lines.

After processing each variable individually, all the explanatory variables (e.g. weather, elevation) were interpolated to a common spatial resolution of 500 m × 500 m to better match satellite NTL resolution. Additionally, two different datasets were created, one where all the variables were aggregated using the census tract into towns and the other where the variables were aggregated into towns subdivisions, using the most appropriate statistical method for each variable. Here, a town is the political boundary, and a town subdivision is a sub-region within the town also referred to as barrio. The selected aggregation method for each variable is listed in Table 1. Consequently, three training datasets were created by changing the spatial resolution of the variables (500 m × 500 m, Towns, and Towns Subdivisions).

TABLE 1

| | | | | |
|---|---|---|---|---|
| Explanatory Variable | Source | Resolution | Units | Aggregation Method |
| Maximum Wind Speed. (WS) | WRF | 1 km × 1 km | MPH | Maximum |
| Duration of Wind Speed greater than 20 MPH. (WS 20) | WRF | 1 km × 1 km | hours | Maximum |
| Duration of Wind Speed greater than 30 MPH. (WS 30) | WRF | 1 km × 1 km | hours | Maximum |
| Duration of Wind Speed greater than 40 MPH. (WS 40) | WRF | 1 km × 1 km | hours | Maximum |
| Cumulative Rainfall. (CR) | WRF | 1 km × 1 km | inches | Maximum |
| Population by Municipios. (POP) | US Census | Towns | count | Maximum |
| Elevation. (EL) | USGS | 100 m × 100 m | feet | Mean |
| Land Cover. (LC) | USGS NLCD | 30 m × 30 m | categorical | Median |
| Pre-Hurricane NTL intensity map. (NTL Base) | NASA VIIRS | 500 m × 500 m | radiance | Mean |

In step 104 radiance data from a satellite nightlight database is extracted for the geographic area at issue before (pre-hurricane radiance data) and after (post-hurricane radiance data) a hurricane-induced power loss event. The pre-hurricane radiance data includes data from at least one day prior to the landfall of the hurricane, wherein that one day is within seven days of the landfall. In another embodiment, the pre-hurricane radiance data includes data from at least two such days. In still another embodiment, the pre-hurricane radiance data includes data from at least three such days. The post-hurricane radiance data includes data from at least one day after the landfall of the hurricane, wherein that one day is within seven days of the landfall. In another embodiment, the post-hurricane radiance data includes data from at least two such days. In still another embodiment, the post-hurricane radiance data includes data from at least three such days.

In step 106, this data is used as a proxy for historical power outage data by calculating a difference in radiance between the pre-hurricane radiance data and the post-hurricane radiance data.

For example, the VIIRS satellite sensor is capable of capturing the upwelling visible and infrared radiance from the Earth at 500 m × 500 m resolution. In this example, the top-of-atmosphere, at-sensor nighttime radiance product (VNP46A1) was used. The cloud-mask layer of the VNP46A 1 product was examined to determine the cloud coverage. To quantify the pre-Hurricane Irma and Maria baseline NTL distribution, the pixels with clouds were removed and aggregated the NTL data between August 20 and Aug. 24, 2017 to a complete, clear-sky mapping of the NTL over Puerto Rico. Since significant cloud cover is associated with hurricanes, it is not always possible to capture the immediate nightlight radiance following landfall. Images were aggregated between September 8 and September 11 to quantify the Hurricane Irma induced power loss. Power was completely recovered by September 17. The cloud cover remained longer for Hurricane Maria with no cloud-free imagery in the first four days following landfall. To create the post-Maria NTL data, the cloud-free part of the island captured in images was aggregated between September 25 and September 30, to construct a cloud-free image for the entire island. Due to the desirability for cloud-free observations of the NTL, the estimates of power loss will be impacted by power restoration during the time between outage occurrence and cloud-free observations. This will result in some underestimation of the total power outages from the derived algorithm.

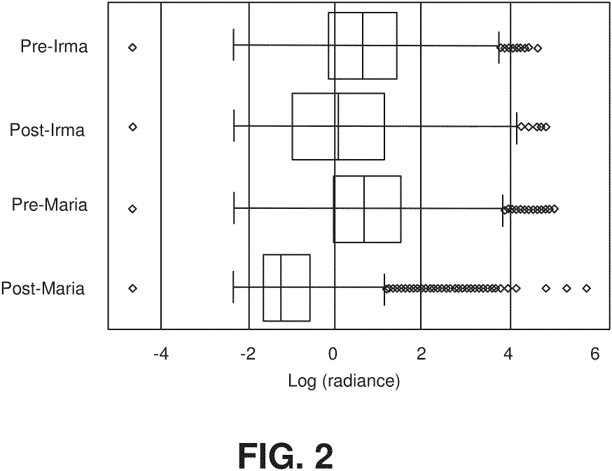

FIG. 2 shows a box plot of log-transformed pixel-level NTL radiance for the entire island. The median log transformed NTL intensity before H-Irma, between August 20 and August 24, was 0.6 which dropped to 0.09 after H-Irma landfall. Between September 17 and September 19, the median radiance became 0.6 which is equal to the intensity prior to Hurricane Irma. This indicates the power infrastructure of the Island completely recovered from the loss caused by Hurricane Irma before the landfall of Hurricane Maria. Therefore, using radiance values between August 20 and August 24 as a baseline for both events would give an unbiased estimation of power loss.

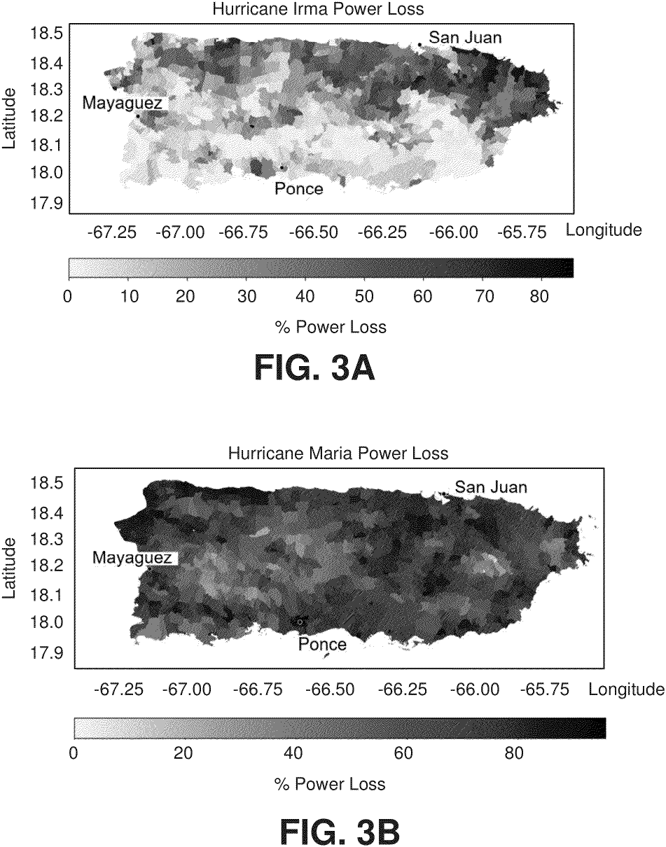

The historical loss in power infrastructure can be formulized as,

$$P o w e r L o s s = \frac{N {L}_{B a s e} - N {L}_{A f t e r}}{N {L}_{B a s e}} \times 100$$

wherein NL_{Base} is the nightlight radiance before and NL_{After} is the radiance after the hurricane. The NL_{Base} was used by itself as an independent variable. In this context power loss represents the change of nightlight radiance and not the actual electricity power loss. Moreover, the power loss metric could be interpreted as the probability of power outage within a given spatial boundary (i.e., 500 m, Towns, and Towns Subdivisions). As shown in FIG. 3A, Hurricane Irma had a notable impact on the power infrastructure, leaving a major power loss on the northeastern side of the island. In contrast, Hurricane Maria severely damaged the power infrastructure, leaving major power loss throughout the island, FIG. 3B.

In step 108 of method 100, the explanatory variables (step 102) and the historical power loss based on the radiance data (step 106) is provided to at least one computerized machine learning model for subsequent processing. The historical power loss based on the radiance data functions as a proxy for traditional power loss data that would normally be provided to the machine learning model. Examples of suitable machine learning models include Bayesian Additive Regression Trees (BART), Random Forest (RF), Extreme Gradient Boosting (XGBoost) and the like.

BART is a data mining, fully Bayesian probability model, with a prior and likelihood. The model is constructed with an ensemble of decision trees. The predictions are made by adding the resulting outputs from each tree together, helping to avoid overfitting in the model. The model can be described with the following equation:

$$Y = {\sum }_{j = 1}^{m} g \left(x , {T}_{j} , {M}_{j}\right) + ε , ε \sim \left(0 , {σ}^{2}\right)$$

wherein Tⱼ is a binary regression tree where Mⱼ = {µ₁ⱼ, µ₂ⱼ ... µ_{bj}} is its terminal node parameters. The g (x, Tⱼ, Mⱼ) function assigns µᵢⱼ ∈ Mⱼ to x. The expected value equals the sum of all the terminal node assigned to x. The term ∈ is the variance component, assumed to follow normal distribution with zero mean.

The nonparametric BART model has been successfully used in different approaches to risk analysis and damage prediction in extreme weather events. Previous reports compared the BART model with survival models by predicting power outage duration in Hurricane Ivan (2004). BART was found to give better results than the traditional survival models. Other reports compared multiple models including generalized additive models, BART, generalized linear models, and classification and regression trees (CART), for the estimation of damage in the distribution poles during hurricane events. Without wishing to be bound to any particular theory, it is believed nonparametric models perform better than parametric models for outage prediction in hurricanes. Previous studies compared two nonparametric tree-based models, BART, and quantile regression forest, concluding that BART was better for predicting the magnitude and spatial variation of outages. Moreover, BART was also found to perform better when the data was aggregated into larger service areas (e.g., Towns Subdivisions).

The RF regression model is also a nonparametric, supervised learning algorithm that averages over the outputs of an ensemble of decision trees to make the predictions. RF follows the bagging technique for training data creation by randomly resampling the original dataset with replacement. From the total set, a small set of input variables is randomly selected for binary partitioning the nodes of a tree. The splitting of the non-terminal node of a regression tree is based on choosing the input variable with the lowest Gini Index.

$${I}_{G} \left({t}_{X \left({x}_{i}\right)}\right) = 1 - {\sum }_{j}^{m} f {\left({t}_{X \left({x}_{i}\right)} , j\right)}^{2}$$

wherein,

$$f \left({t}_{X \left({x}_{i}\right)} , j\right)$$

is the proportion of samples with value xᵢ belonging to leave j as node t. The final prediction of the model is done by averaging all trees.

XGBoost is a scalable end-to-end tree boosting system that follows the principle of greedy function approximation of a gradient boosting algorithm. XGBoost utilizes additional regularized-model reinforcement to regulate overfitting to enhance performance. XGBoost uses a tree ensemble technique which refers to the utilization of a set of CART, and the final prediction is the sum of each CART’s score. For prediction, the XGBoost minimizes the following regularized objective function.

$$L \left(ϕ\right) = {\sum }_{i} l \left(\hat{y} , {y}_{i}\right) + {\sum }_{k} Ω \left({f}_{k}\right)$$

$$Ω \left(f\right) = γ T + \frac{1}{2} λ {\left‖ω\right‖}^{2}$$

Here, l is a convex loss function that measures the difference between predicted (ŷ) and true value (yᵢ). Moreover, Ω is the regularization parameter that penalizes the complexity of the model to avoid overfitting, where T represents the number of leaves and ||ω||² is the L2 norm of all leaf scores. The parameters γ and λ control the degree of conservatism when searching the tree.

To implement the BART in the disclosed method, the R library “BartMachine” was selected. This library was chosen over the BayesTree R package mainly for its capability to run in parallel, giving higher efficiency in the training process. For the BART model, a five-fold cross-validation was used and a total of 50 trees were selected, the other hyperparameters were set to default. In the training process, 250 burn-in iterations were performed and discarded. Another 1000 iterations were made to build the regression trees. Using a random hyperparameter grid search with 150 replicates of the model and a five-fold cross-validation the optimal hyperparameters for the RF were found to be 100 trees, a maximum depth of 126 for each tree, a maximum of four features considered for splitting a node, a minimum of five data points placed in a node before the node is split and default for the remaining. Similarly, a five-fold cross validation random hyperparameter grid search with 150 replicates of the model was used for XGBoost. The selected hyperparameters were gbtree as the booster, a total of 100 decision trees, a maximum depth of the tree of 10, a learning rate of 0.3, and a minimum weight of 1 to create a new node in the tree.

In step 110, the machine learning model then forecasts hurricane-inducted power loss using the explanatory variables and the historical power loss based on the radiance data as inputs. Advantageously, the machine learning model is not provided with any direct power loss data.

The power loss data may be provided to an end user (e.g. a local government, municipality, utility provider, etc.) in the form of a tabulated data table listing local geographic regions (e.g. 500 m × 500 m squares, towns subdivisions, or town) with a predicted percentage of power loss. Alternatively or additionally, an intensity map of the area may be provided with the different geographic regions color-coded based on the predicted power loss. See FIGS. 3A and 3B for examples of intensity maps.

In one embodiment, multiple machine learning models are trained using historical data and the optimal model (as determined by matching the forecasted data to actual historical data) is selected. For example, to test the sensitivity of the models (BART, RF, XGBoost) at different spatial granularities, the models were each formulated at three different spatial levels: (1) 500 m × 500 m, (2) towns subdivisions level, and (3) towns level. Root Mean Square Error (RMSE), Mean Absolute Error (MAE), and R-Squared (R2) were used to compare the prediction capabilities of the model at different resolutions. Moreover, a mean-only model was used as a benchmark for BART, RF, and XGBoost.

Table 2 reveals that, for the current example, the RF and XGBoost models had higher explained variance (R2) for the 500 m × 500 m resolution and the towns subdivisions aggregation. Mainly because the training dataset size was significantly reduced due to the larger areas of aggregation (towns). Pixel resolution, on the other hand, offers the model with a vast dataset to train on. Furthermore, the RMSE shows that the 500 m resolution has errors of greater magnitude in all models. Owing to the pixel level daily NTL dataset being noisier and skewed. Most importantly, combining the pixels into a larger spatial resolution minimizes noise and aids in the removal of the skewed response variable distribution.

TABLE 2

Comparison of Model Resolutions Performance, Test Dataset

| Resolution | Metrics | Mean Only | BART | RF | XGBoost |
|---|---|---|---|---|---|
| 500 m x 500 m | RMSE | 31.81 | 18.46 | 13.16 | 15.16 |
| | MAE | 27.8 | 14.48 | 9.10 | 11.16 |
| | R2 | NA | 0.67 | 0.82 | 0.77 |
| Towns | RMSE | 23.86 | 13.05 | 13.59 | 13.65 |
| | MAE | 19.65 | 9.71 | 10.45 | 10.27 |
| | R2 | NA | 0.70 | 0.66 | 0.66 |
| Towns Subdivisions | RMSE | 29.32 | 13.76 | 12.51 | 12.84 |
| | MAE | 25.80 | 10.49 | 9.42 | 9.66 |
| | R2 | NA | 0.79 | 0.82 | 0.81 |

The towns subdivision aggregation had the smallest prediction error in most of the models as the training dataset remained large enough for a reliable training process. Furthermore, the models had a small variance in the predictions with minimal large residuals in all the resolutions, as indicated by the closeness of the RMSE to the MAE value.

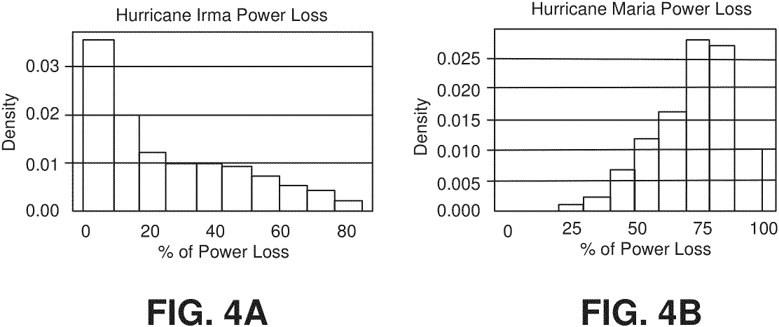

Referring to FIG. 4A and FIG. 4B, in the disclosed examples, power loss was analyzed in each storm independently. The behavior of the power loss was very different in each storm. Hurricane Maria had very high winds and precipitation. As a result, it caused more severe damage throughout the island, leaving most of the island with 70% to 100% power loss. Hurricane Irma was less destructive, leaving most of the island with minimum power loss. Consequently, both storms are used as training events, allowing the disclosed method to be sensitive to both types of events. To build the training dataset, 70 % of the data were randomly selected from both Hurricane Irma and Hurricane Maria. The remaining 30% of both storms data was left out of the training process and used to test the method. Explanatory variables in Table 1 were used in conjunction with the power loss as inputs in the training process.

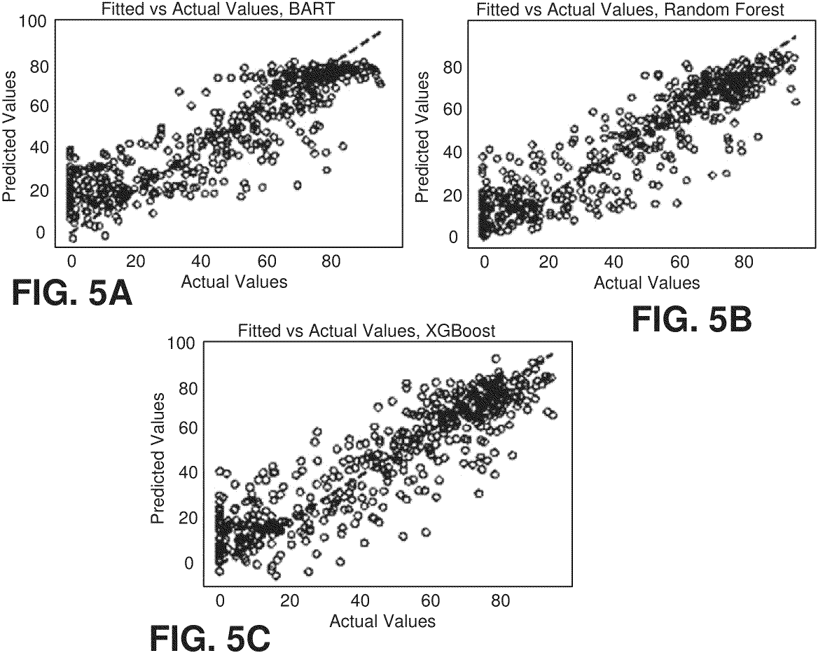

When comparing the predicted power loss with the actual power loss, all three models (BART, RF, and XGBoost) performed similarly well on the test dataset (FIG. 5A, FIG. 5B and FIG. 5C). However, the RF model at towns subdivisions resolution was chosen as the best configuration because it had fewer large residuals in the predictions and the explained variance outperformed the other models by a small margin.

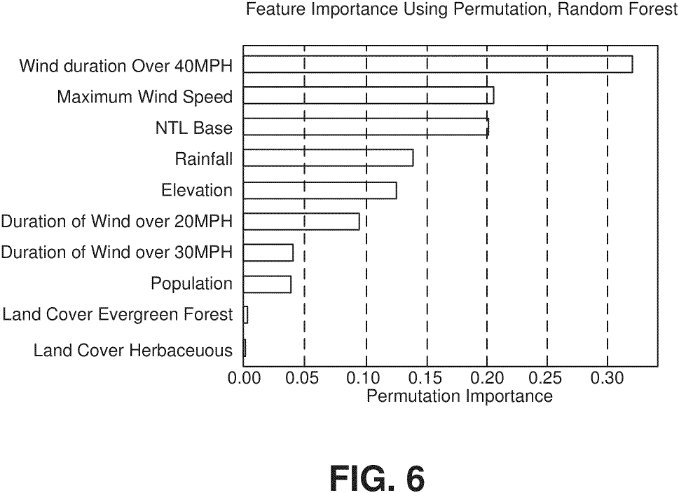

After selecting the optimal configuration of the model, the importance of each variable in the model as a predictor was determined. In order to get a stable study in the test dataset, permutation features importance with 100 replicates of RF were used to generate variable inclusion proportions (see FIG. 6).

As expected, the first three variables with the most influence in the prediction are weather-related variables that quantify the magnitude of the hurricane. Moreover, the duration of winds over 40 MPH had a higher inclusion proportion than the wind speed magnitude, implying that longer times of high wind exposure can be more critical than maximum wind gusts for power loss estimation. Among land cover types, the evergreen forest is detected as an important predictor for power outages. That is plausible as this land type has a high risk for overhead transmission and distribution lines due to falling trees.

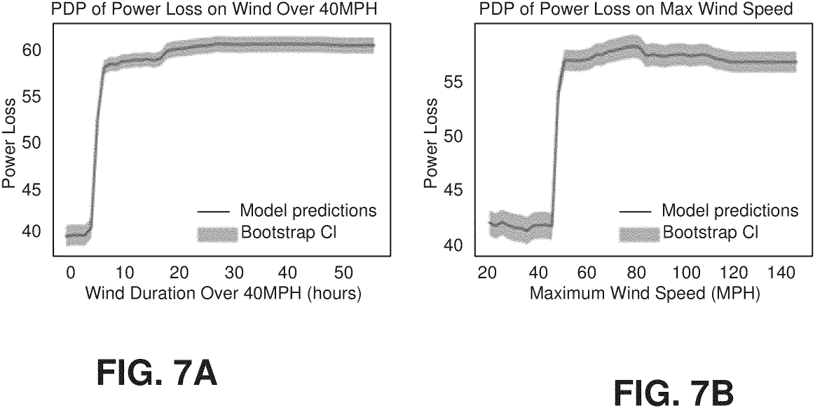

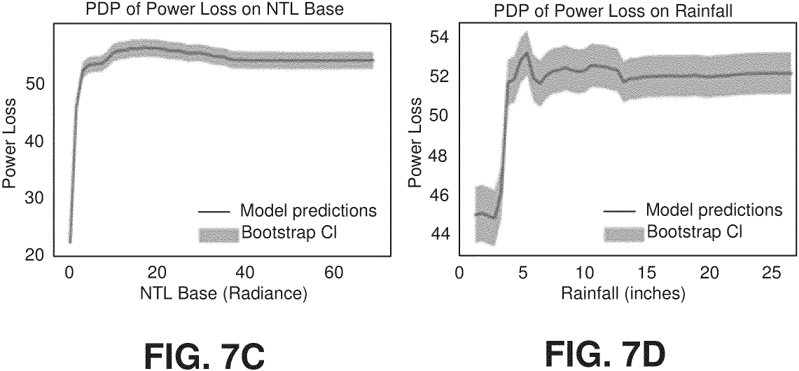

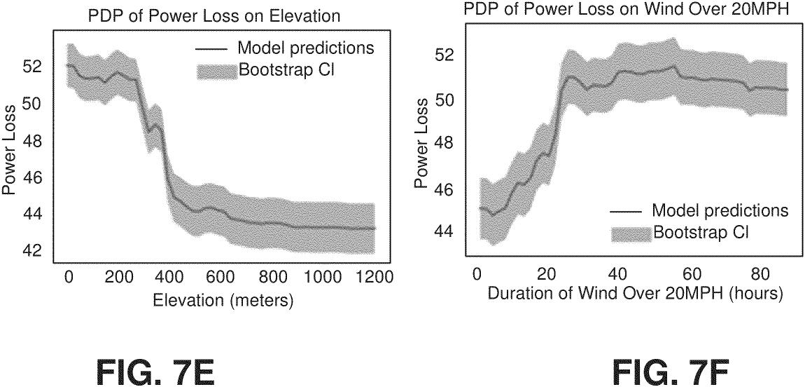

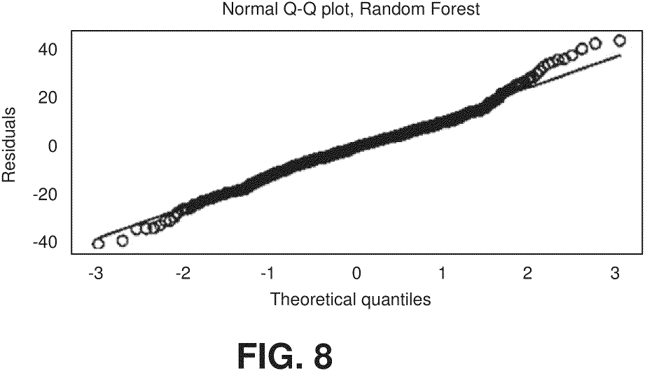

To further investigate the influence of the explanatory variables with highest inclusion proportion, we created partial dependence plots (PDP) were created See FIG. 7A, FIG. 7B, FIG. 7C, FIG. 7D, FIG. 7E and FIG. 7F. The PDP were created using 50 bootstrap resamples and a confidence interval of 95%. The PDP shows that a higher duration of wind over 40 MPH strongly influences the power loss. Similarly, the maximum wind speed and rainfall influence the power loss as they increase. However, the influence plateaus when the duration of wind over 40 MPH, maximum wind speed, and rainfall reaches 25 hours, 80 MPH, and 13 inches, respectively. Additionally, one can see an increase in the influence on power loss when the NL_{Base} increases from 0 to 5. This shows how the NL_{Base} helped the model achieve a better distribution of the power loss over the island, by giving information on service areas with low NTL radiance, such as rural areas with a small customer count. Finally, looking at the quantile-quantile plot (QQ-plot) in FIG. 8, one sees that most of the residuals fall along the 45-degree line, which indicates that the residuals follow a normal distribution. This shows that the RF model can capture the variability in the dataset.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of forecasting hurricane-induced power loss, without using power outages records, the method comprising:
aggregating explanatory variables selected from a group consisting of maximum wind speed, duration of wind speed greater than 20 mph, duration of wind speed greater than 30 mph, duration of wind speed greater than 40 MPH, cumulative rainfall, human population, elevation, land cover, and combinations thereof, the aggregating occurring for at least one time period when hurricane-induced power loss occurred over a geographic area due to a hurricane;
extracting radiance data from satellite nighttime light (NTL) data for the geographic area during the at least one time period when hurricane-induced power loss occurred, thereby creating extracted radiance data that includes pre-hurricane radiance data and post-hurricane radiance data;
approximating a historical power loss by calculating a difference between the pre-hurricane radiance data and the post-hurricane radiance data;
training at least one machine learning model to predict a future power loss by using the explanatory variables and the historical power loss, and
forecasting hurricane-induced power loss using the at least one machine learning model, thereby producing a forecasted power loss.

2. The method as recited in claim 1, wherein the training at least one machine learning module trains multiple machine learning models, the method further comprising selecting the optimal machine learning model for predicting the power loss, wherein the forecasting uses the optimal machine learning model.

3. The method as recited in claim 1, wherein the at least one machine learning model is a Bayesian Additive Regression Trees (BART) machine learning model.

4. The method as recited in claim 1, wherein the at least one machine learning model is a Random Forest (RF) machine learning model.

5. The method as recited in claim 1, wherein the at least one machine learning model is an Extreme Gradient Boosting (XGBoost) machine learning model.

6. The method as recited in claim 1, further comprising providing a data table to an end user, the data table listing local geographic regions within the geographic area and corresponding predicted power losses.

7. The method as recited in claim 1, further comprising providing an intensity map to an end user, the tabulated data table listing local geographic regions within the geographic area and a corresponding predicted power loss.

8. The method as recited in claim 1, wherein the explanatory variables consist of meteorological variables, geographic variables and demographic variables.

9. The method as recited in claim 1, wherein the explanatory variables omit power outage reports.

10. The method as recited in claim 1, further comprising creating a partial dependence plot of the forecasted power loss versus at least one of the explanatory variables.

11. The method as recited in claim 1, wherein the pre-hurricane radiance data includes data from at least one day that is within seven days of landfall of the hurricane.

12. The method as recited in claim 1, wherein the pre-hurricane radiance data includes data from at least two days that are within seven days of landfall of the hurricane.

13. The method as recited in claim 1, wherein the pre-hurricane radiance data includes data from at least three days that are within seven days of landfall of the hurricane.

14. The method as recited in claim 1, wherein the post-hurricane radiance data includes data from at least one day that is within seven days of landfall of the hurricane.

15. The method as recited in claim 1, wherein the post-hurricane radiance data includes data from at least two days that are within seven days of landfall of the hurricane.

16. The method as recited in claim 1, wherein the post-hurricane radiance data includes data from at least three days that are within seven days of landfall of the hurricane.
